(19) United States
(12) Patent Application Publication
(10) Pub. No.: US 2006/0052064 A1
(43) Pub. Date: Mar. 9, 2006

(54) Carrying case for cell phone or other device with protective end cap and cushioning

(75) Inventor: Harold S. Goradesky, Fort Lauderdale, FL (US)

Correspondence Address: ROBERT C. KAIN, JR., 750 SOUTHEAST THIRD AVENUE, SUITE 100, FT LAUDERDALE, FL, 333161153, US

(73) Assignee: A.G. Findings & Mfg. Co., Inc.

(21) Appl. No.: 11/118,651

(22) Filed: Apr. 30, 2005

Related U.S. Application Data
(60) Provisional application No. 60/608,023, filed on Sep. 8, 2004.

(51) Int. Cl. H04B 1/38; H04B 1/08; H04M 1/00

(52) U.S. Cl. 455/90.3; 455/575.1; 455/347

(57) ABSTRACT

The carrying case for a cell phone or other small electronic device includes a front, a rear, two opposing sides and a bottom. A resilient plastic bottom end cap forms a protective shield at the bottom. The end cap may include recessed grooves and/or raised lands to enhance impact resistance and/or provide a tactile response structure. The front side wall of the carrier may include a soft cushion edge pad along its upper edge to facilitate phone or device removal and insertion into the carrier. A carrier may also include bands of cushioning material about its sides which define shock resistant elements to protect the intermediate portions of the carried device. To better grip the device or phone, the case may include a swath of elastic with or without a releasable fastener system extending over the swath of elastic.

This is a regular application that claims the benefit of priority of provisional patent application No. 60/608,023 filed Sep. 8, 2004, now pending.

The present invention relates to a carrying case for cellular telephones or other personal electronic devices such as personal data assistants (PDA), digital cameras, digital memory store music players (for example IPODS (Apple Computer Co. trademark), MP3 players) portable game players and other small, portable, electronic devices commonly carried by a person.

### BACKGROUND OF THE INVENTION

Many persons carry cellular telephones and/or other personal electronic devices such as personal data assistants (PDAs). Cell phones and PDAs audibly announce a call to the user (the person carrying the personal electronic device). If the cell phone or device is located in a briefcase, purse, handbag or backpack, the user does not hear the audible announcement and does not respond to the audible signal. Therefore, many persons carry cell phones and other small electronic devices on their belts, purse straps or on a tether which loops around the person's neck or over their shoulder. Additionally, some people carry digital memory store music players such as MP3 players and Ipods which play music through earphones inserted into the ear of the user. Portable game players, such as the PSP (Sony trademark) game player, are also carried by users. These personal electronic devices are typically carried in a pocket or attached to a belt or a purse strap by a tether or strap discussed above. Digital cameras are sometimes carried in quickly accessible places on a person's body such that the person can quickly remove the camera and capture a unique event in a camera digital memory store.

In these situations, when the cell phone or personal electronic device is carried on the outside of the body of the user (or on a purse or strap), the cell phone or personal electronic device is subject to damage by being dropped, by ejection of the cell phone or device from the holster or carrier or damaged if the user bumps a wall, door jam or other object when the cell phone or device is hung on or attached to the user's belt or a tether or a purse strap. Therefore, it is beneficial to provide a carrying case which reduces impact and shock to the cell phone or personal electronic device.

### OBJECTS OF THE INVENTION

It is an object of the present invention to provide a carrying case for a cell phone or other personal electronic device.

It is an additional object of the present invention to provide a carrying case which includes a resilient plastic bottom end cap which forms a protective shield for the bottom end of the cell phone or personal electronic device.

It is an additional object of the present invention to provide a carrying case which includes an end cap with tactile response features which notifies the user when the user brushes or bumps against a wall, door jam or other structure indicating to the user that he or she is in danger of damaging the cell phone or device carried on the hip of the user.

It is a further object of the present invention to provide a carrying case wherein the end cap spans only a portion of the lateral aspect of the front and/or spans the left or right bottom edge of the cell phone or device since those portions are subject to significant damage due to impact and shock.

It is a further object of the present invention to provide a carrying case with a cushioned edge pad along the top edge of the front wall of the case which facilitates insertion of the cell phone, reduces wear along the front edge of the carrying case and provides an additional degree of protection from impact at that upper edge portion of the carrier.

It is another object of the present invention to provide a V-shaped cutout on the soft cushion edge pad to enable the user to better grip the cell phone or device and to remove the cell phone or device from the carrier. This cutout also assists in the insertion of the phone or device into the case.

It is a further object of the present invention to provide a carrying case which utilizes bands of cushioning material about the front wall and side walls of the carrier to reduce impact and shock damage to the cell phone or device.

It is another object of the present invention to provide tactile ridges and/or valleys on the bands of cushion materials along the sides of the carrying case to provide a tactile grip region permitting the user to insert and to withdraw the cell phone or other personal electronic device from the carrier without difficulty.

It is a further object of the present invention to provide a carrier with a swath of elastic material which permits the carrier to securely grip various cell phones or other devices having different sizes in the case. The elastic swath may be inside or outside the carrier.

It is another object of the present invention to provide some type of releasable fastener system spanning the swath of elastic material to more securely grasp and contain the cell phone or other device within the carrier.

It is a further object of the present invention to provide a carrying case including a tether loop attachment mounted with a lacing system.

### SUMMARY OF THE INVENTION

The carrying case for a cell phone or other small electronic device includes a front, a rear, two opposing sides and a bottom. A resilient plastic bottom end cap forms a protective shield at the bottom. The end cap may include recessed grooves and/or raised lands to enhance impact resistance and/or provide a tactile response structure. The front side wall of the carrier may include a soft cushion edge pad along its upper edge to facilitate phone or device removal and insertion into the carrier. A carrier may also include bands of cushioning material about its sides which define shock resistant elements to protect the intermediate portions of the carried device. To better grip the device or phone, the case may include a swath of elastic with or without a releasable fastener system extending over the swath of elastic.

### BRIEF DESCRIPTION OF THE DRAWINGS

Further objects and advantages of the present invention can be found in the detailed description of the preferred embodiments when taken in conjunction with the accompanying drawings in which:

FIG. 1A diagrammatically illustrates the carrying case for a cell phone or other personal electronic device and diagrammatically illustrates a portion of the cell phone or other personal electronic device about to be inserted into the carrying case;

FIGS. 1B, 1C and 1D diagrammatically illustrate different carrying case mounting systems to mount the carrying case to the belt, purse strap or button type female clip-on structure;

FIG. 2A diagrammatically illustrates another embodiment of the carrying case showing a case with two swaths of elastic material and the impact resistant resilient end cap;

FIGS. 2B and 2C diagrammatically illustrate a portion of a bottom side view of the carrying case of FIG. 2A and a portion of the front side wall segment of the carrying case of FIG. 2A;

FIG. 3 diagrammatically illustrates another embodiment of the carrying case showing swaths of elastic and the bottom end cap;

FIGS. 4 and 5 diagrammatically illustrate carrying cases with swaths of elastic and fastener systems;

FIGS. 6A and 6B diagrammatically illustrate a carrying case with a single swath of elastic and a side view of that carrying case;

FIG. 7 diagrammatically illustrates a carrying case with swaths of elastic material, a velcro fastening system and bands of cushion material to protect the cell phone or device from side and front impact;

FIGS. 8 and 9 diagrammatically illustrate other carrying cases with an elastic band segment (FIG. 8) and a different fastener system (the button fastener of FIG. 9) and tactile response and grip side elements for the case as well as bands of cushion material;

FIGS. 10 and 11 diagrammatically illustrate other embodiments of the carrying case with elastic capture bands and a lacing system for securing the cell phone or device in the case;

FIGS. 12A and 12B diagrammatically illustrate the bottom end cap and the side cushions as well as the bottom view of the bottom end cap showing raised lands which act as shock resistant elements;

FIG. 13 diagrammatically illustrates the use of a swath of elastic and a lacing fastener system;

FIGS. 14 and 15 diagrammatically illustrate carrying cases with elastic, bands of cushion material, tactile grip areas and shock resistant elements in the bottom end cap;

FIGS. 16 and 17 diagrammatically illustrate carrying cases with bands of cushion material, bottom end caps, tactile grip regions, and shock absorbing cushion and end cap elements;

FIGS. 18 and 19 diagrammatically illustrate carrying cases with a cushion edge pad along the upper top of the front wall of the carrying case and bands of cushion material along the side walls and front wall;

FIGS. 20 and 21 diagrammatically illustrate carrying cases with various shock absorbing elements, bands of cushion material and elastic retainer bands;

FIGS. 22 and 23 diagrammatically illustrate carrying cases with tactile grip regions and shock absorbing elements in the form of bands of cushion material;

FIGS. 24 and 25 diagrammatically illustrate carrying cases with different bands of cushion material and different bottom end caps;

FIGS. 26 and 27 diagrammatically illustrate other constructions of the carrier with a V-shaped cutout in the soft cushion edge pad and a large soft cushion edge pad at the top of the front wall of the carrier;

FIGS. 28 and 29 diagrammatically illustrate carriers with elastic elements and V-shaped cutouts along the cushion edge pad and tactile grip surfaces along the sides of the carrier;

FIGS. 30 and 31 diagrammatically illustrate carriers having bands of cushion material, shock absorbing elements on those bands of cushion material and shock absorbing elements at the bottom end cap of the carriers;

FIGS. 32 and 33 diagrammatically illustrate carriers with cushion edge pads along the front wall, bands of cushion material along the side wall and bottom end caps with shock resistant elements;

FIG. 34 diagrammatically illustrates carriers with V-shaped cutouts in the cushion edge pad, bands of cushion material and bottom end caps with shock resistant elements;

FIG. 35 illustrates a case with bands of cushion material in a regular sequence which sequence forms a grip region for the user and tactile response regions.

FIGS. 36 and 37 diagrammatically illustrate carriers with elastic swaths and large bands of cushion material as well as bottom end caps;

FIGS. 38 and 39 diagrammatically illustrate carriers with elastic portions interposed between bands of cushion material;

FIGS. 40 and 41 diagrammatically illustrate carriers with cushion edge pads and V or U-shaped cutouts (representing very shallow V-shaped cutouts) along the edge pads as well as bottom end caps with shock resistant elements;

FIGS. 42A diagrammatically illustrates a carrier with a bottom end cap and a tether loop attachment along the rear wall of the carrier;

FIG. 42B diagrammatically illustrates a carrier and particularly the clip-on device for the carrier; and

FIGS. 43A and 43B diagrammatically illustrate a lacing system and the tether loop associated with the lacing system.

### DETAILED DESCRIPTION OF THE PREFERRED EMBODIMENTS

The present invention relates to a carrying case for a cellular telephone or other personal electronic device such as a personal data assistant, a digital camera, a digital memory store music player, portable game player or other very small portable personal electronic device.

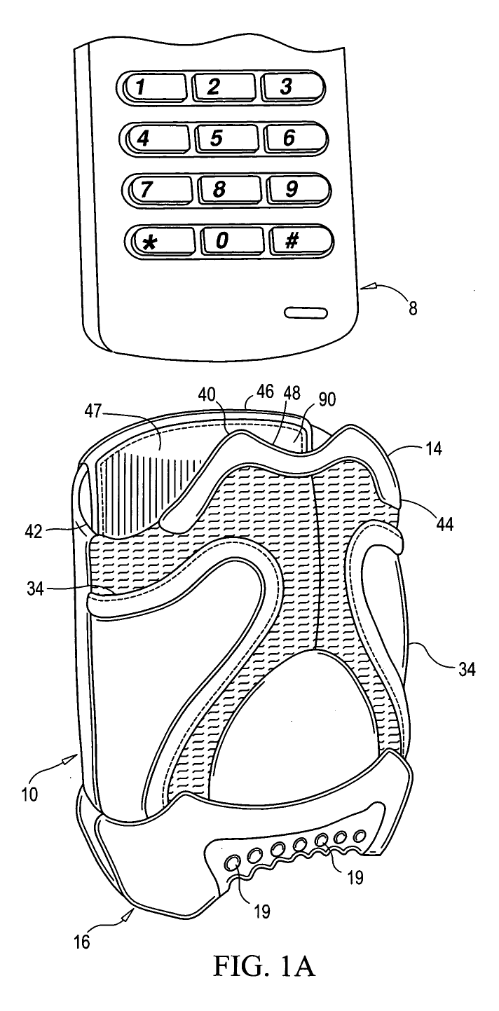

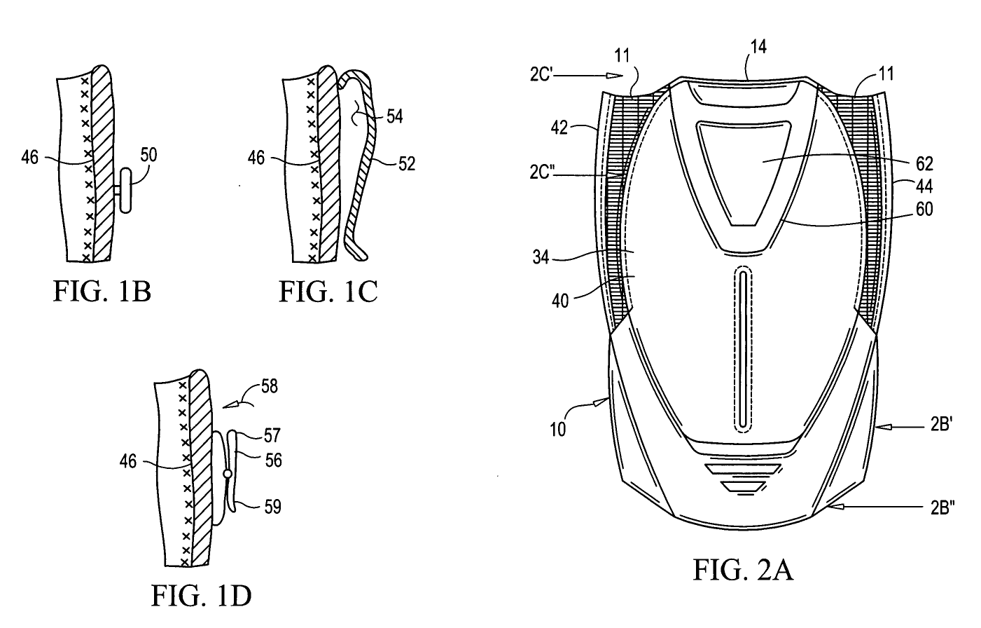

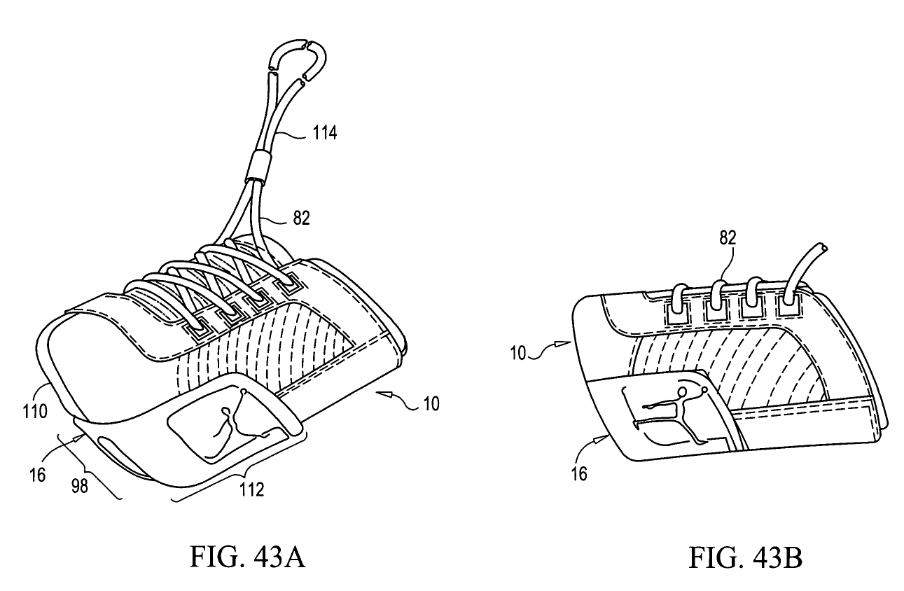

FIG. 1A diagrammatically illustrates carrying case 10. Similar numerals designate similar items throughout all of the drawings. Several of the drawings are discussed concurrently herein. Carrying case 10 includes front side 40, opposing side walls 42, 44 and rear wall 46. A cellular telephone or other personal electronic device 8 is adapted to the inserted into the open top region 47 defined by mouth 48. Mouth 48 is defined by the top edges of front side 40, left side 42, right side wall 44 and rear wall 46 of carrier 10. The cell phone or the personal electronic device 8 has a bottom end 9. Bottom end 9 fits within a resilient plastic boot end cap 16. End cap 16 is attached to the front rear and two opposing sides 40,42, 41, 46 in the embodiment illustrated in FIG. 1A. The end cap may only partially span the entire lateral aspect of the case. See, for example, FIG. 43A.

In order to cushion and provide shock resistance and a tactile response element, bottom end cap 16 has certain structural features shown in the other figures. The FIG. 1A case includes recesses 19. The bottom end cap 16 is made of resilient compressible plastic such that if the cell phone held within the case is dropped by a user, the case and particularly bottom end cap 16 is designed to absorb a reasonable amount of impact shock thereby limiting the damage to the cell phone or other device carried by carrier 10. Front side wall 40 and left side wall 42 and right side wall 44 include, in the embodiment in FIG. 1A, bands of cushion material 34 which span portions of walls 40, 42 and 44 to protect the cell phone or other device carried in the space defined by those walls and bottom end cap 16.

Front side 40 along open top 47 and mouth 48 includes, at least along a lateral portion thereof, a soft cushion edge pad 14. This soft cushion edge pad 14 facilitates insertion of the cell phone or other device into mouth 47 and the enclosure defined by walls 40, 42, 44 and 46. Also, edge pad 14 provides additional shock resistance and protection from impact. Further, edge pad 14 reduces wear to the front wall due to the repeated insertion and removal of the cell phone or other device into and through open top 47. Edge pad 14 defines shallow V-shaped cutout 90 which facilitates phone insertion and removal.

FIGS. 1B, 1C and 1D diagrammatically show various attachment mechanisms that may be secured or mounted to rear side wall 46 of the carrying case. In FIG. 1B, a protruding button 50 is the male portion of a button clip on system. The female portion of these button clip on systems include a female receiver or a receiving channel known to others of ordinary skill in the art. Button clip mounting systems are described in U.S. Pat. No. 6,799,354; and application Ser. No. 10/791,128 filed Mar. 2, 2004, the content of which is incorporated herein by reference thereto. In FIG. 1C, rear wall 46 of the carrying case 10 includes a S-shaped clip 52 which the user places behind a belt or a strap to capture the belt or strap in space 54 between clip 52 and rear wall 46. In FIG. 1D, a compressible or spring loaded clip 56 is utilized. End 57 of clip 56 is moved in the direction of arrow 58 to open the opposing mouth of clip 56. The strap or belt is placed in the mouth and is compressed by spring action between the base of clip 56 and the tooth end 59 of clip 56. Other attachment mechanisms may be utilized to attach carrying case 10 to a belt, purse strap or other type of strap item.

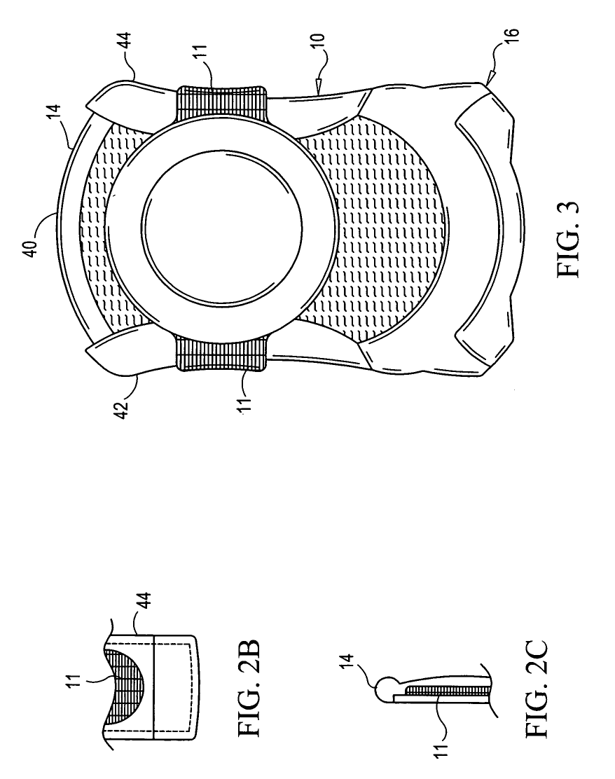

FIG. 2A diagrammatically illustrates carrying case 10 wherein front side 40 includes a large cushion band 34 which protects the cell phone or other device carried and encased by carrying case 10. Cushion material or band 34 includes a raised land 60 and a depressed or recessed region 62. These raised lands and depressed regions, if made of compressible or resilient plastic material, provide additional shock resilient elements. Otherwise, or in addition thereto, the raised land 60 and depressed plate 62 provide a tactile region which informs the user that he or she has bumped or scrapped the cell phone or device against a wall, door jam or other structure. This tactile warning reduces the probability that the user may further damage the phone or device by additional impact against such structures. FIG. 2A also shows that front side 40 includes 2 swaths of elastic material 11. The swaths of elastic material permit the side walls 42, 44 to expand and contract and thereby better capture and restrain the cell phone or other device in the interior of the carrying case.

FIG. 2B shows a side view of a portion of the carrying case shown in FIG. 2A from the perspective of section line 2B′-2B″. Along the side wall 44, an additional swath of elastic material 11 is disposed. The left side wall 42 also has a further swath of elastic material. Elastic side walls compress the phone or device in the z axis.

FIG. 2C is a partial, cut away view of the carrying case of FIG. 2A from the perspective of section line 2C′-2C″ in FIG. 2A. Carrying case 10 in the illustrated embodiment of FIG. 2A includes a soft cushion edge pad 14 at its upper edge of front wall 40.

FIG. 3 shows cell phone and device carrier 10 having elastic swaths 11 on the left and right sides about left side wall 42 and right side wall 44. A cushion edge pad 14 is disposed at the upper edge of front side 40.

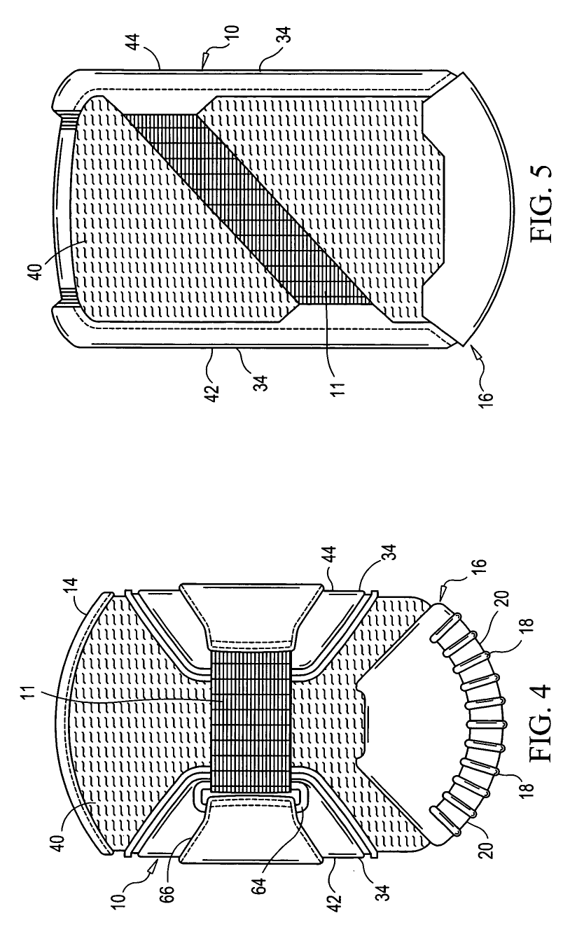

FIGS. 4 and 5 diagrammatically show different embodiments of the cell phone or device carrier 10. Elastic bands or swaths 11 are disposed across front wall 40. Carrying case in FIG. 4 has an edge pad 14. That case also includes bands of cushion material 34 which extend not only over a portion of front side 40 but also about left side and right side 42, 44. A fastener mechanism 64 enables the user to close elastic strap 11 onto fixed element 66. In FIG. 5, the elastic band material 11 is fixed. Beneath the elastic material is a thin nylon cloth structure which permits the carrying case to somewhat collapse to grasp and retain the cell phone therein and limit ejection of the cell phone from the case or reduce the probability that the phone or device falls out of the case.

In FIG. 4, bottom end cap 16 includes a plurality of raised lands or ridges 18 and a plurality of depressed valleys or grooves 20. These items provide an additional shock absorbing characteristic for the end cap and also provide a tactile responder to the user.

FIG. 5 has bands of cushion material 34 on the left side and right side walls 42, 44.

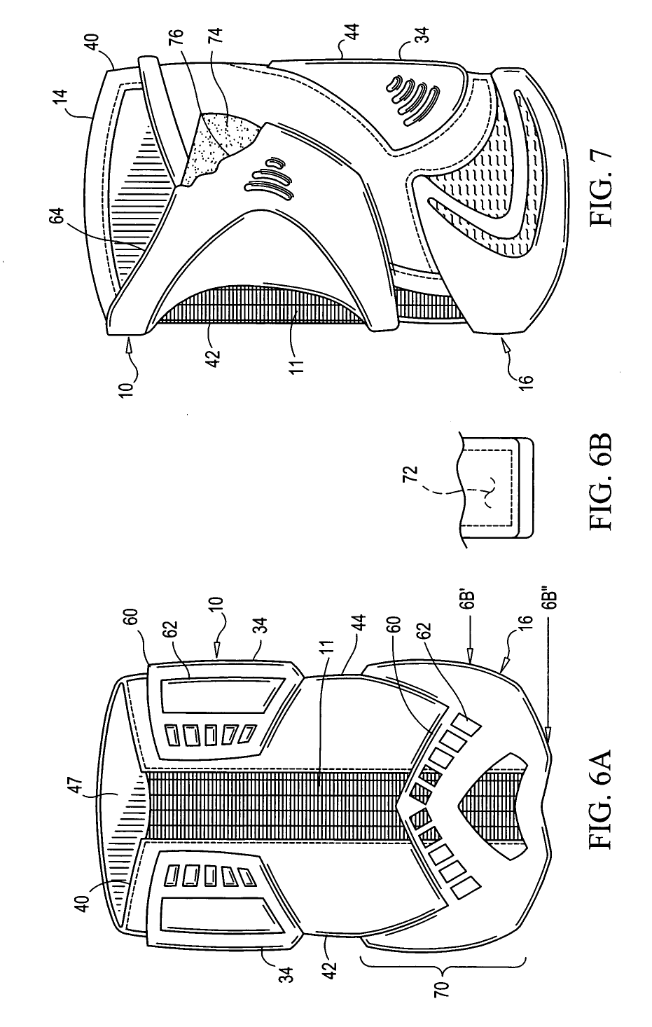

FIG. 6A shows a central disposition of elastic swath 11 on front wall 40 of the carrying case 10, cushion material 34 on left side and right side 42, 44 as well as on the front side 40 and raised lands 60 and depressed regions 62 formed on the cushion material. These raised lands 60 and depressions 62 provide additional shock resistance and impact resistance as well as a tactile response region. Further, these raised lands and depressions enable the user to better grip the carrying case during removal and insertion of the cell phone or other device. The structures form grip regions about the case. The bottom end cap 16 extends longitudinally or along the y axis up the side of both left and right sides 42, 44 as shown in region 70 along side 42. The lateral (x axis) extension of end cap 16 about sides 42,44 provides wrap around end cap regions which additionally enhance the cushioning effect and protection of the electronic device carried by carrier 10.

FIG. 6B is a small section of the carrying case shown in FIG. 6A from perspective of section lines 6b′-6b″. The cell phone or electronic device is placed in space 72 in the interior of the carrying case 10.

FIG. 7 shows elastic segments 11 along one side 42 of carrying case 10. The top edge of front side 40 includes an edge pad 14. In order to adjust the interior space of the cell phone/device carrier or configure the compressive force of elastic 11, a fastener system 64 includes a hook and loop cloth fastener sometimes called a VELCRO fastener shown as VELCRO fastener elements 74, 76. An additional elastic swath may be disposed beneath flap fastener 64 as part of front wall 40. Cushion material 34 at right side 44 protects the electronic device in the carrying case. Other fastener systems may be used such as buttons, snaps, belts and belt clasps, other types of clasps, or lacing systems.

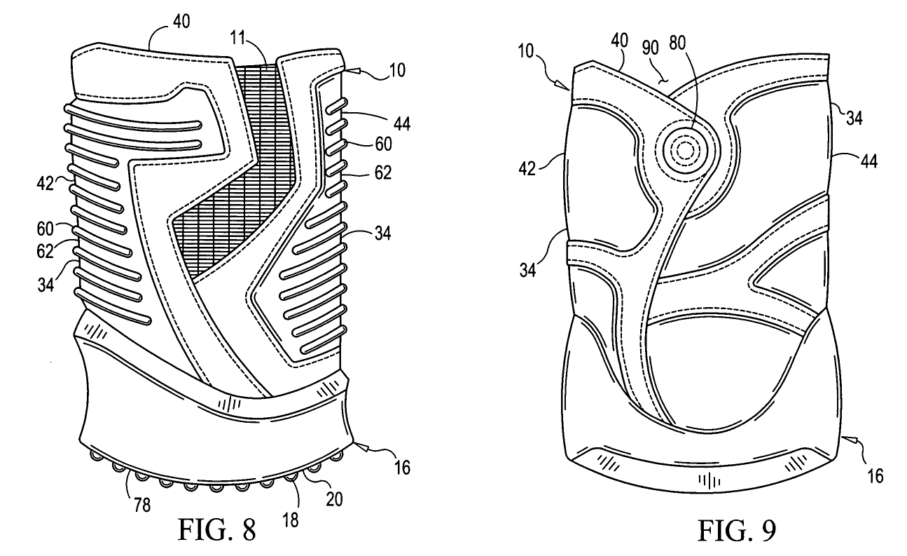

FIGS. 8 and 9 show carrying cases 10. Elastic panel 11 in the carrying case of FIG. 8 permits the user to expand or contract the interior space of the carrying case to carry different size cell phones and electronic devices. Cushion panels 34 along sides 42, 44 as well as front side 40 carry raised lands 60 and depressed regions 62. FIG. 8 shows that the tactile response region is greatly enhanced by this plurality of raised lands rising above depression 62 on bands of cushion material 34. Additionally, the multitude of raised lands 60 provide a high quality grip regions along sides 42,44. With respect to bottom end cap 16, the lower face 78 includes a plurality of protrusions or ridges 18 rising above valleys or depressed regions 20. When bottom end cap 16 is made of compressive or resilient material, this end cap provides protection to the cell phone or other electronic device. The end cap with these structural features (raised lands) provides a tactile responsive surface when the user brushes up against a chair arm when he or she sits in a chair.

With respect to FIG. 9, left side and right side 42, 44 have bands of cushion material 34 thereon. Additionally, the front panel 40 is split into two panels and a button fastener 80 is disposed on the front surface 40. Alternatively, fastener 80 could be a snap or other type of clasp (such as a T-bar clasp or hook and loop clasp). Elastic may be disposed as an interior wall panel beneath the fastener system.

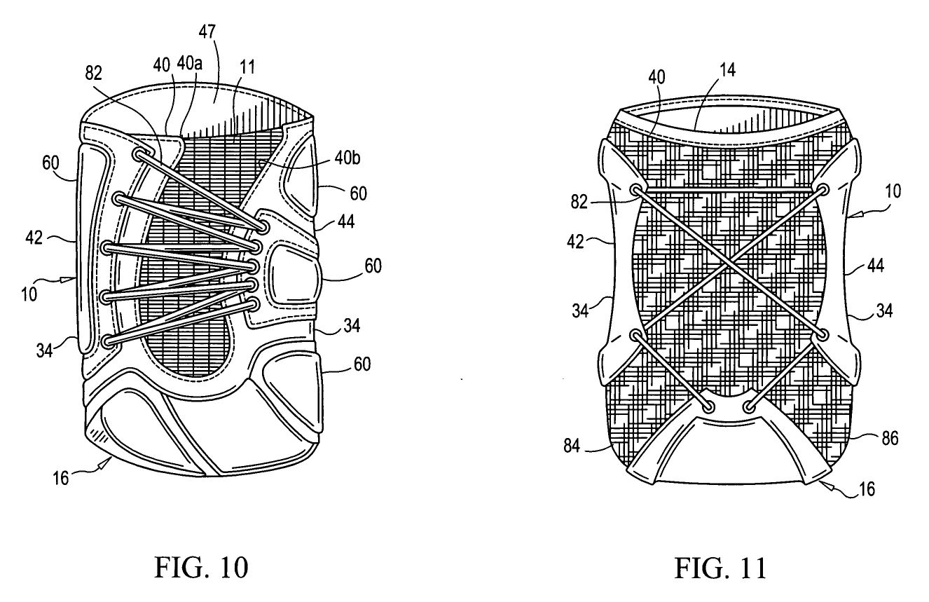

FIG. 10 shows a front side wall 40 that is split into two sections by elastic swath 11. A lacing fastener system 82 is employed to join front element 40a with front element 40b. Sides 42, 44 also include cushion panel materials 34 and side 44 includes several raised lands 60 which provide for protection, tactile response when the case is rubbed against the wall or other structure as well as a gripping region.

FIG. 11 shows a case with an edge pad 14 and laces 82 that can constrict the material on front side 40. The soft cushion material 34 is disposed on left and right sides 42, 44. End cap 16 only spans a portion of the lateral expense of bottom of carrying case 10. This design exposes regions 84, 86 to impact and shock.

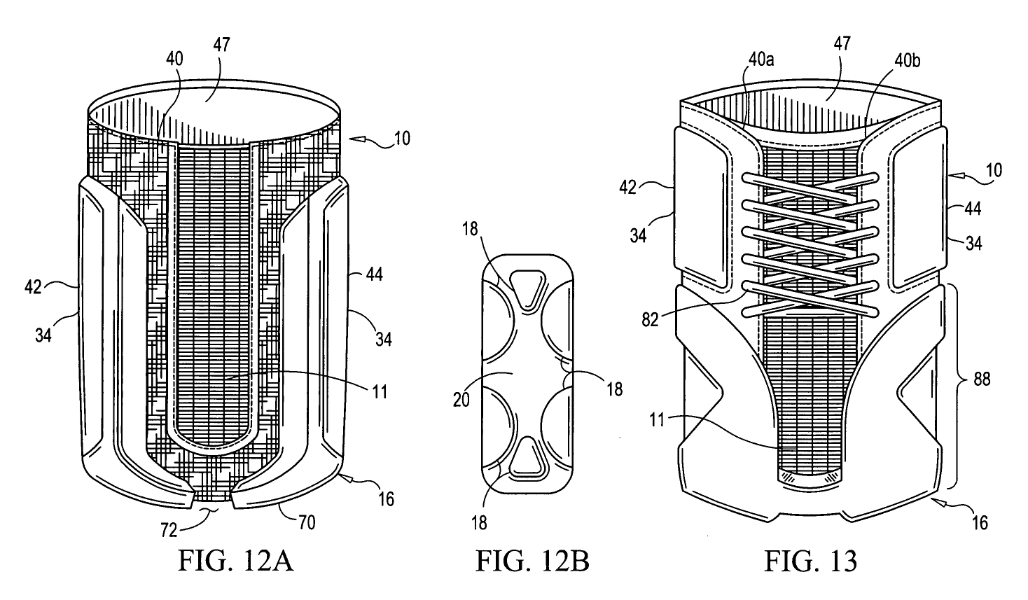

FIG. 12A shows a carrying case with elastic material 18 and bands of cushion material 34 on sides 42, 44 as well as, to some degree, on front side 40. The bottom end cap 16 includes a raised land 70 and a depression 72. Other lands and depressions are illustrated. FIG. 12B is a bottom view of bottom end cap 16 showing a plurality of raised ridges 18 rising above a depressed plane or valley 20. These raised lands rising above depressed plane 20 provide additional shock absorbing and impact absorbing characteristics.

FIG. 13 shows laces 82 spanning elastic swath 11 between front side element 40a, 40b. Cushion panel 34 spans part of front side panels 40a and 40b as well as sides 42, 44. The bottom end cap 16 extends a substantial longitudinal distance 88 above the height of side walls 42, 44. The user can adjust the compression on the cell phone or electronic device by adjusting the laces 82.

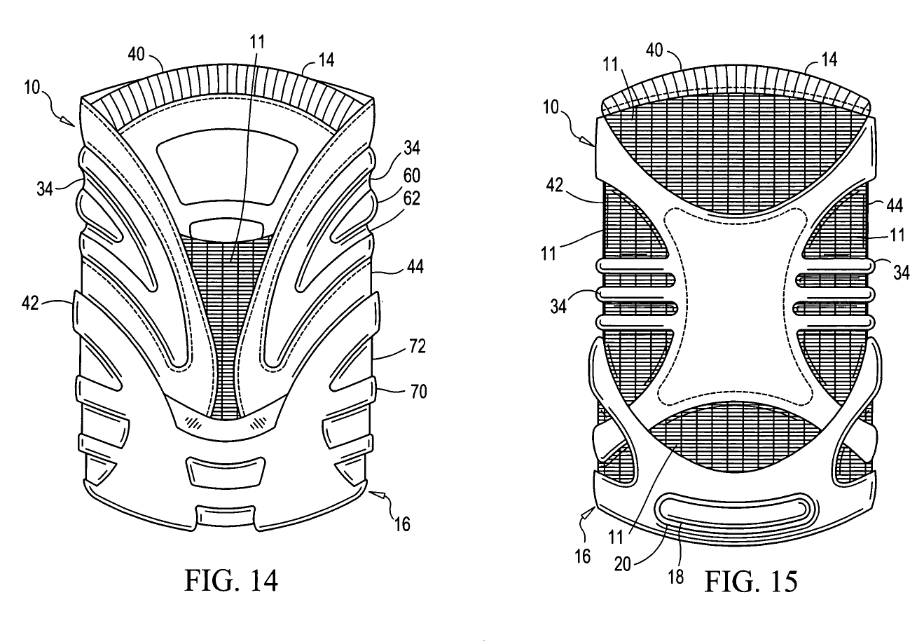

FIG. 14 shows raised lands 60 on cushion materials 34 on sides 42 and 44 as well as front side 40. Bottom end cap 16 also includes a plurality of raised lands 70 and depressions 72 which match the frequency and serial spacing of raised lands 60 and depressions 62 on bands of cushion material 34. This periodic presentation of raised material and depression forms a grip surface consisting of both the bands of cushion material 34 as well as raised lands on bottom end cap 16.

FIG. 15 shows a significant amount of elastic material 11 and bands of cushion material 34 extending across front side 40 and between left and right sides 42, 44. Bottom end cap 16 includes a single raised ridge or bubble 18 surrounded by a depression or valley 20. The utilization of a bubble containing different material (possibly gas) to absorb shock provides another shock absorbing aspect as part of the carrying case in FIG. 15.

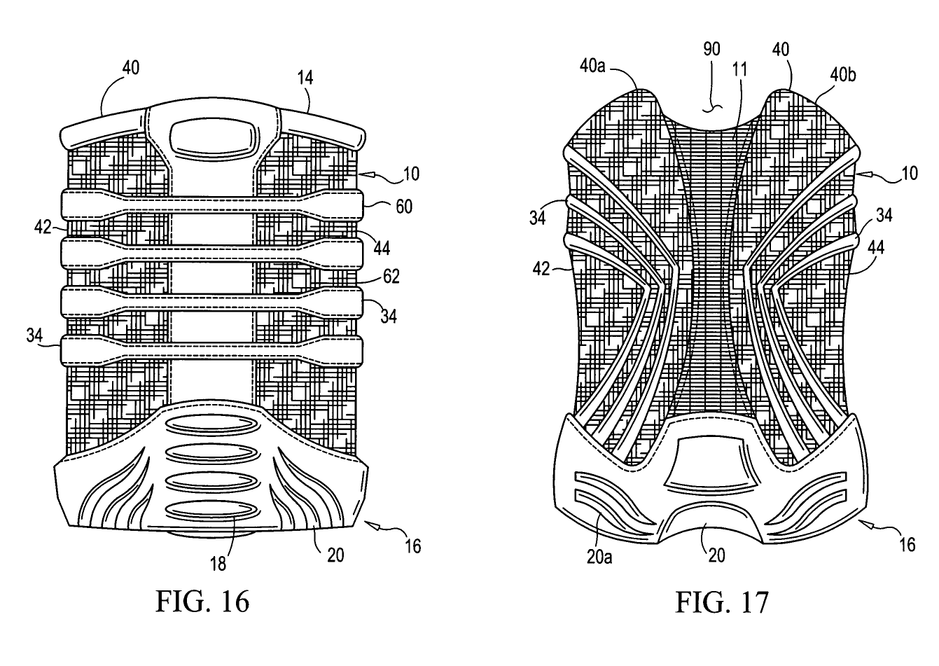

FIG. 16 shows an edge pad cushion 14, side walls 42, 44 and front wall 40 carrying bands of cushion material 34. End cap 16 includes a plurality of raised ridges 18 and depressed valleys 20. The raised ridges and the valleys provide shock absorbency and tactile response.

FIG. 17 shows a swath of elastic 11 between front side elements 40a and 40b. End cap 16 shows a significant depression 20 and minor depressions 20a which provide tactile response regions and grip regions.

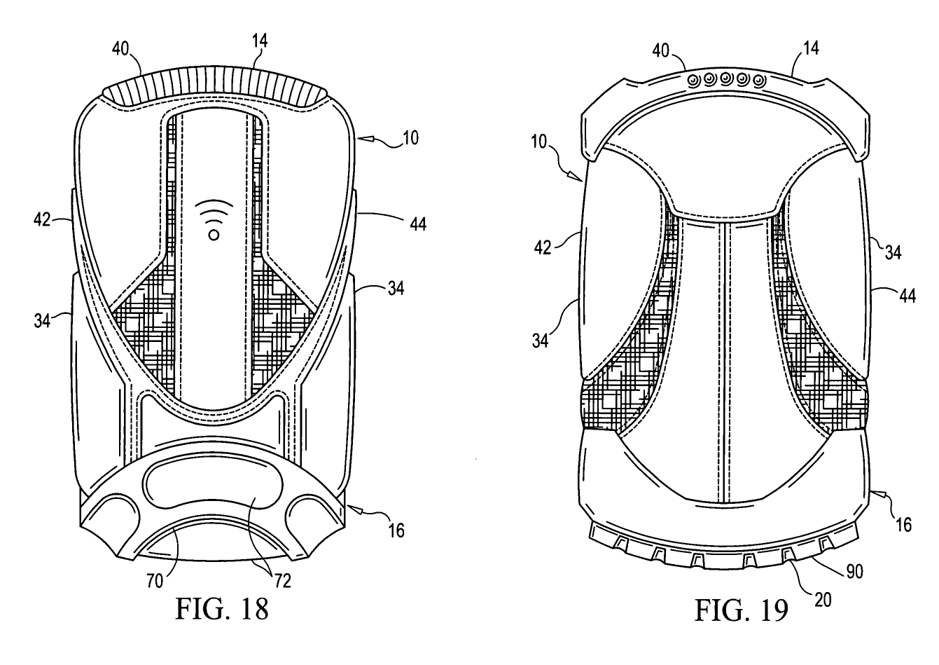

FIG. 18 shows bands of cushion material 34 which extend about sides 42 and 44 as well as partially about front side wall 40. End cap 16 includes recessed or depressed areas 72 adjacent raised land 70. The raised land 70 forms a semi-circle about the carrier body which provides shock protection.

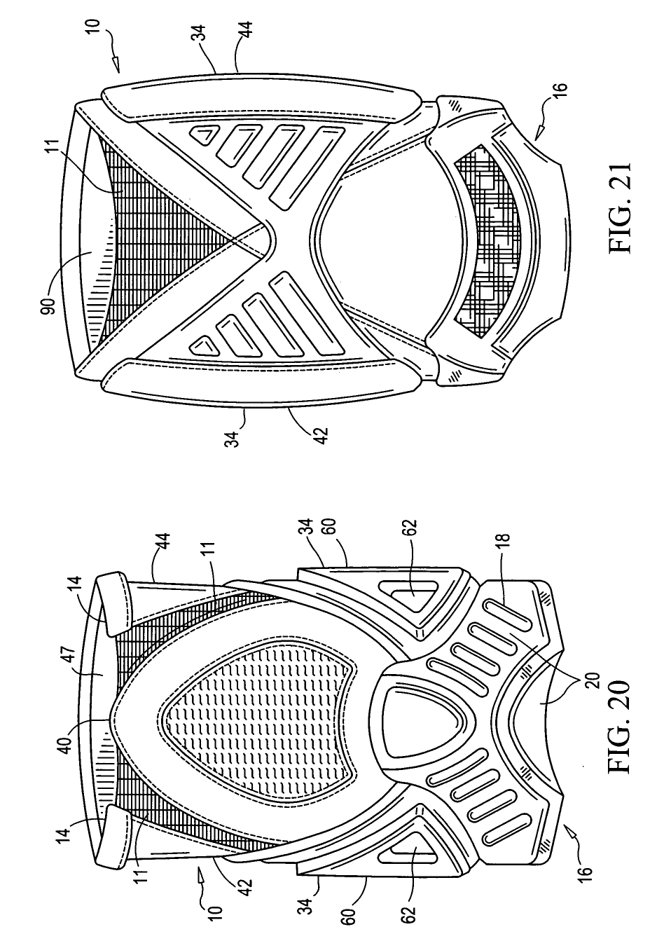

FIG. 19 shows carrier 10 with cushion material 34 about side walls 42, 44 and throughout a substantial region of front wall 40. Edge pad 14 is disposed at the top of front wall 40. At end cap 16, lower surface 90 includes a plurality of valleys 20.

FIG. 20 shows side walls 42, 44 and front wall 40 having raised lands 60 encompassing depression 62 above bands of cushion material 34. Elastic 11 provides some expansion, contraction and compression for open top 47. End cap 16 has a large valley 20 and a plurality of raised ridges or lands 18 between valleys 20 and the end cap has end regions generally running a substantial portion in height up front wall 40. This increase in height of end cap 16 along front wall 40 (longitudinally up the case) provides additional protection for the cell phone or device inserted into open top 47.

FIG. 21 shows bands of cushion material 34 about sides 42, 44 and elastic 11 forming part of a shallow V-shaped cutout 90. The V-shaped cutout 90 is also present in the cases shown in FIGS. 1A, 9 and 17 and enables the user to easily grasp the top of the cell phone or other electronic device and withdraw the cell phone or device from the interior 47 of the carrier.

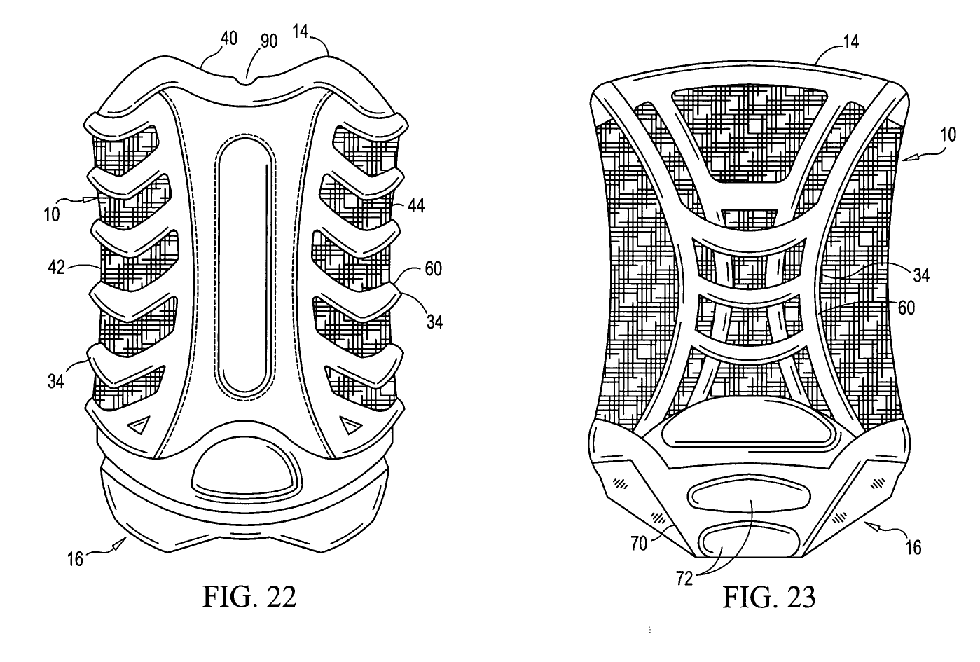

FIG. 22 also shows the V-shaped cutout 90 in edge pad 14 along front side 40. Sides 42, 44 and part of front side 40 also include bands of cushion material 34 that are formed as raised lands 60. Shock protection, tactile response and grip enhancement is provided thereby.

FIG. 23 shows bands of cushion material 34 also formed as raised lands 60 which provide impact resistance and tactile response surfaces. End cap 16 includes recessed areas 72 surrounded by raised land 70 to provide shock resistance.

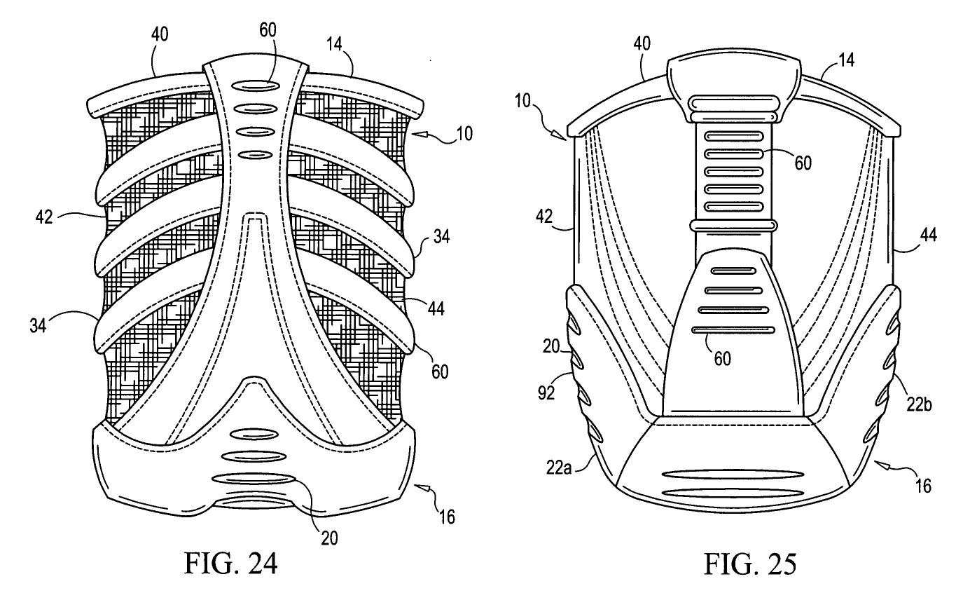

FIG. 24 shows carrying case 10 with bands of cushion material 34 about sides 40, 42 and 44 wherein those bands of cushion material are raised lands 60. In addition, further raised lands 60 are found in the upper portion of the front wall 40 near edge pad 14.

FIG. 25 shows end cap regions 22a, 22b of end cap 16 extending longitudinally a substantial height along sides 42, 44. This enhances the shock protection of the carrying case along the sides. Raised lands 60 provide tactile response and provide a gripping region.

Valleys 20 are defined below surface 92.

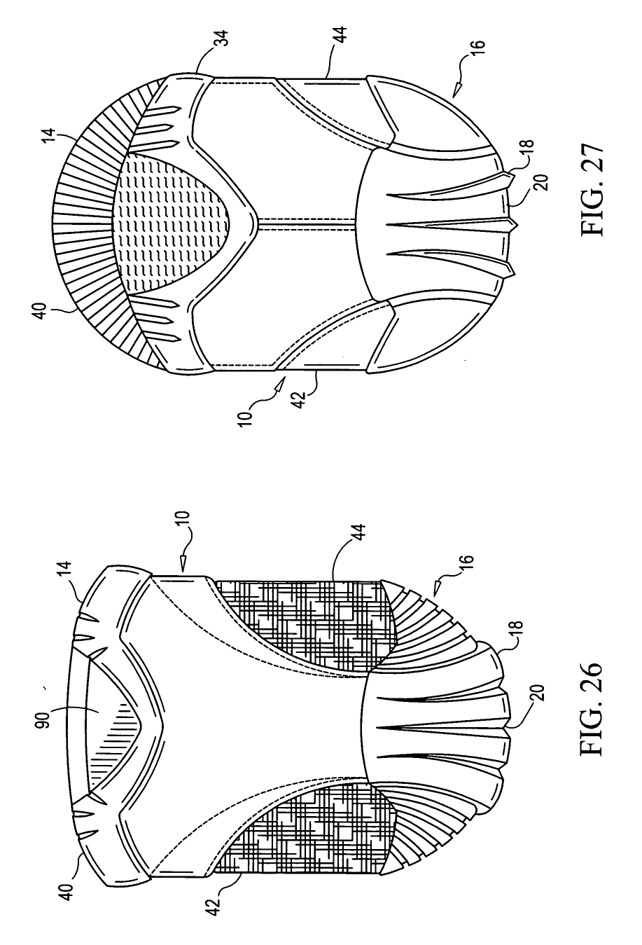

FIG. 26 shows edge pad 14 having a V-shaped cutout 90 and end cap 16 having a plurality of valleys 20 interposed between ridges or raised lands 18.

FIG. 27 shows a large edge pad 14, with a large cross-sectional radial aspect, and a band of cushion material 34 extending across front wall 40 from left side wall 42 through right side wall 44. End cap 16 includes ridges or lands 18 rising above depression or valleys 20.

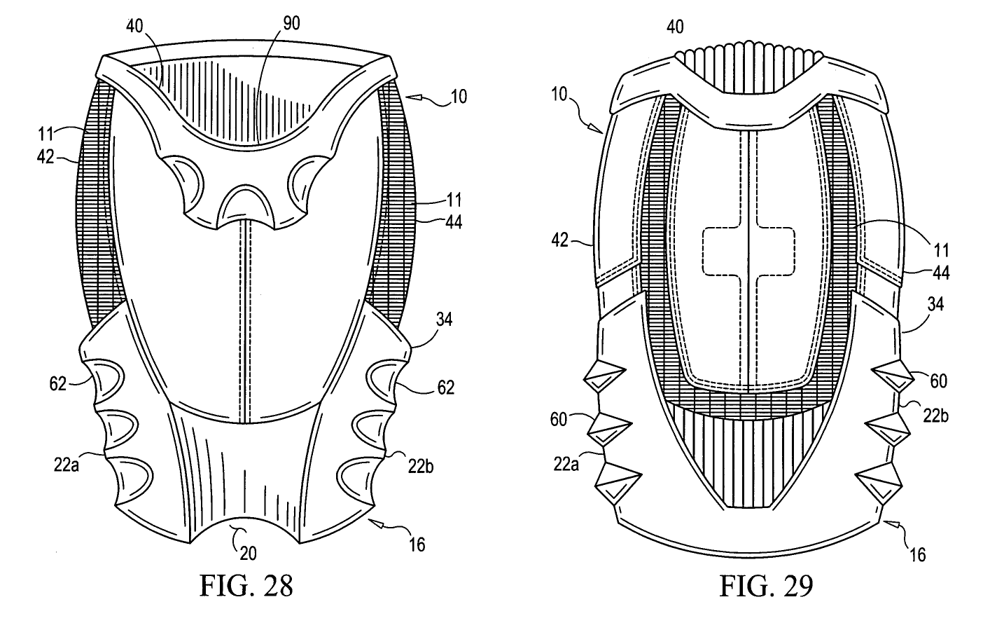

FIG. 28 shows a shallow V-shaped cutout 90 in the top edge of front wall 40. Elastic 11 is disposed at side walls 42, 44. End cap 16 includes substantial end cap regions 22a, 22b which include a plurality of depressions 62. Depressions 62 provide a grip region.

FIG. 29 shows carrying case 10 with elastic 11 and end cap 16 having raised lands 60 about end cap regions 22a, 22b. These provide grip regions for the user.

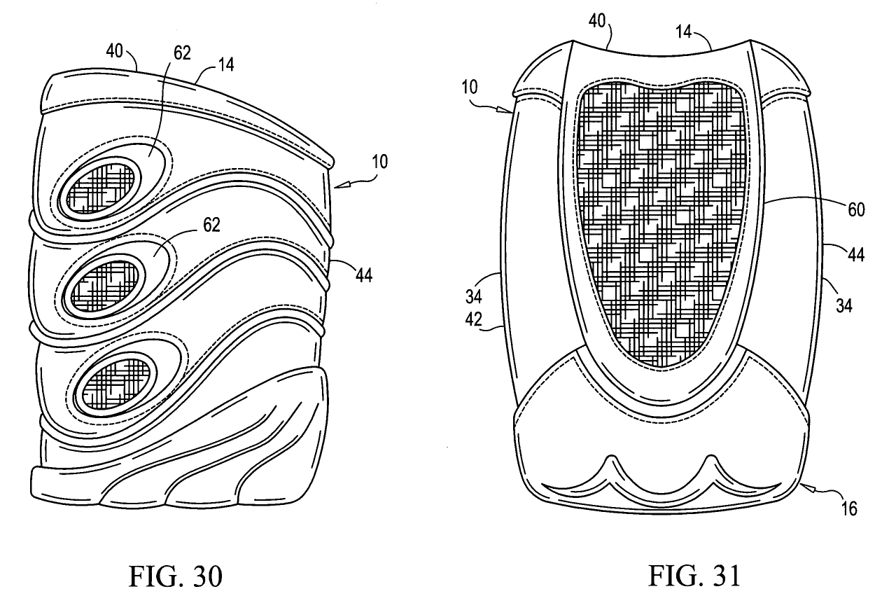

FIG. 30 shows carrying case 10 with bands of cushion material 34 having raised lands 60 and depressions 52. These items provide tactile response areas and grip surfaces about front wall 40.

FIG. 31 shows that front surface 40 includes left and right bands of cushion material 34 and a large, U-shaped raised lands 60.

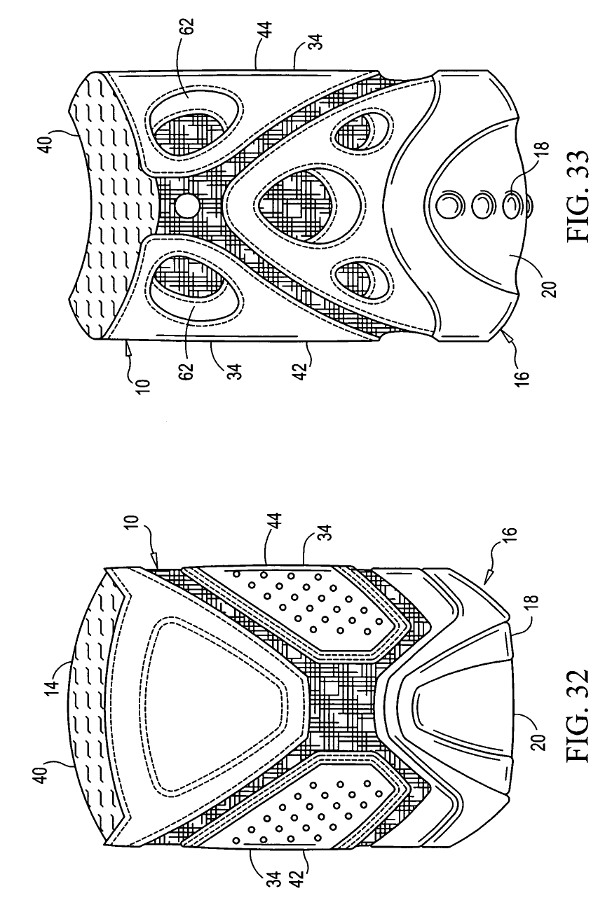

FIG. 32 shows front wall 40 with an edge pad 14 and end cap 16 with a depression or valley 20 adjacent ridge 18.

FIG. 33 shows front wall, left wall and right wall 40, 42 and 44 carrying bands of cushion material 34. Depressions 62 provide tactile response regions. End cap 16 includes ridges or raised bumps 18 rising above a depression or valley 20.

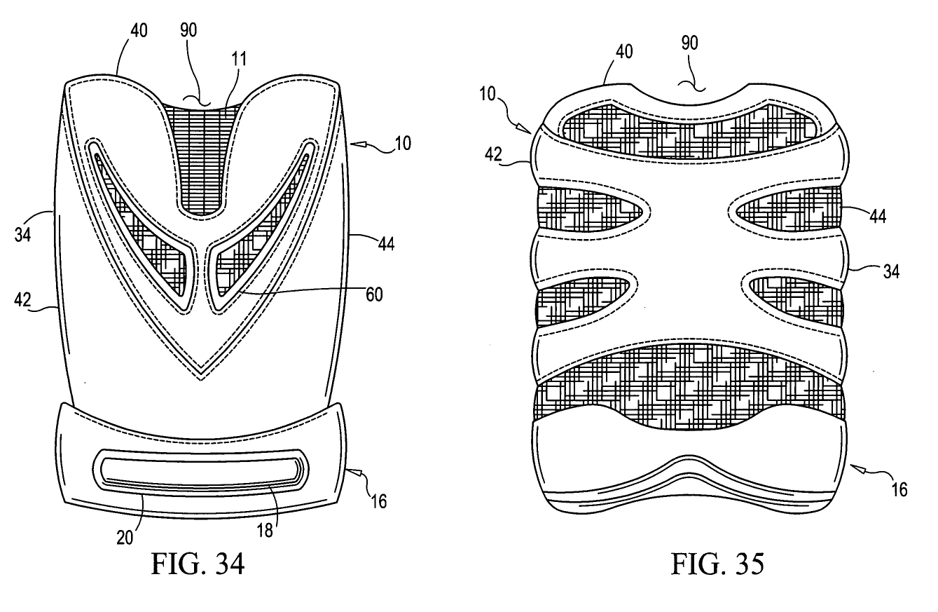

FIG. 34 shows a shallow V-shaped cutout 90 and front wall 40. A large region of cushion material 34 is disposed about walls 40, 42 and 44. Raised lands 60 provide tactile and grip surfaces. Raised land 18 provides a shock absorbent bubble structure for end cap 16. Different material (possibly air) is encased in the bubble.

FIG. 35 shows bands of cushion material 34 spanning walls 40, 42 and 44. Shallow V-shaped cutout 90 permits the user to insert and withdraw the cell phone or other electronic device.

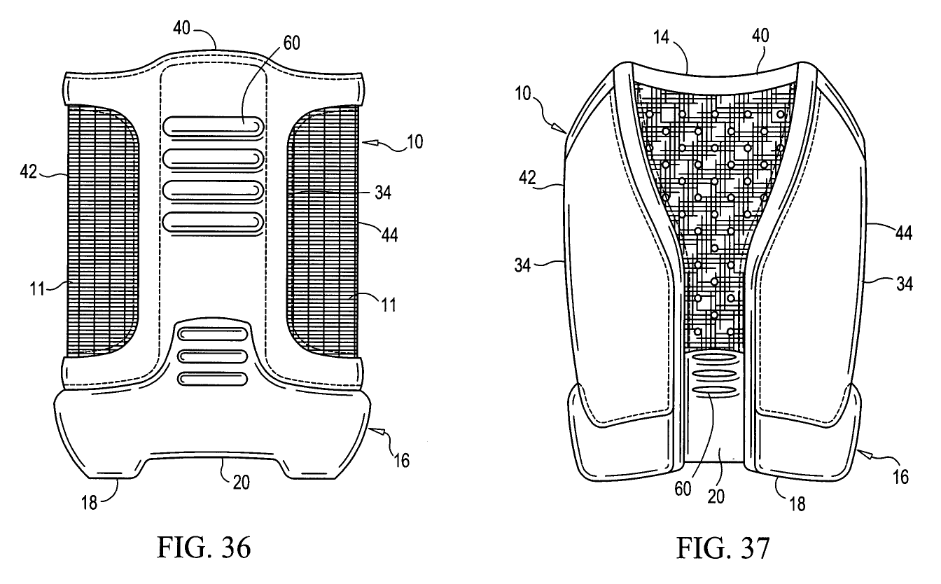

FIG. 36 shows elastic 11 about side walls 42, 44 and a portion of front wall 40. Raised lands 70 rising above cushion material 34 on front wall 40 provide a tactile response and a grip surface. End cap 16 includes a valley or depressed region 20 which provides some shock resistance when operating in conjunction with raised land 18.

FIG. 37 shows a large portion of cushion material 34 about front side 40 and left side and right side 42,44. Raised lands 60 provide some tactile response in the event of the user brushing against a structure.

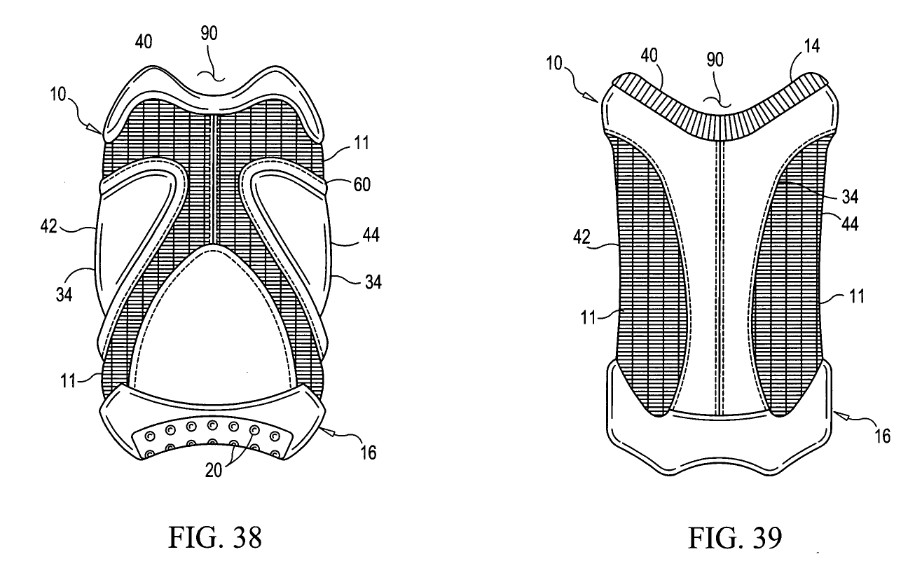

FIG. 38 shows cushion material 34 on walls 40, 42 and 44 and raised lands 60 defining the outer boundaries of the cushion material 34. End cap 16 has a lower surface with a plurality of recesses 20. The upper edge of front wall 40 includes an edge pad 14 with a shallow V-shaped cutout 90.

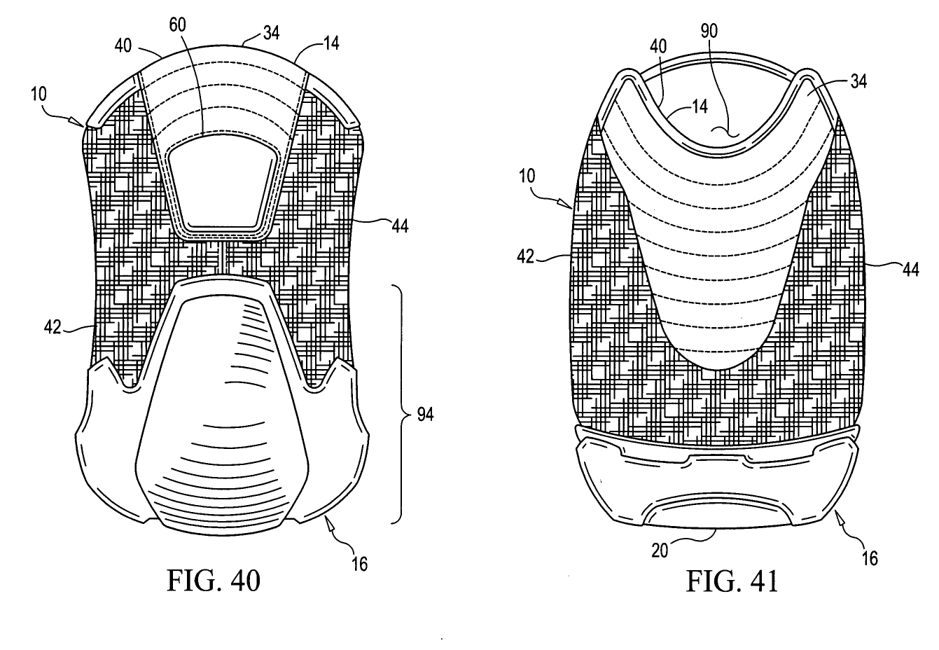

FIG. 39 shows elastic 11 spanning a significant region of front face 40 and side walls 42, 44. Cushion material 34 is attached to this elastic material. The top edge of front wall 40 is a shallow V 90.

FIG. 40 shows carrying case 10 with an edge pad 14, and a area of cushion material 34. Raised land 60 provides some shock or impact resistance to items in the carrying case. End cap 16 extends a sizable distance 94 horizontally (longitudinally upwards) above front wall 40.

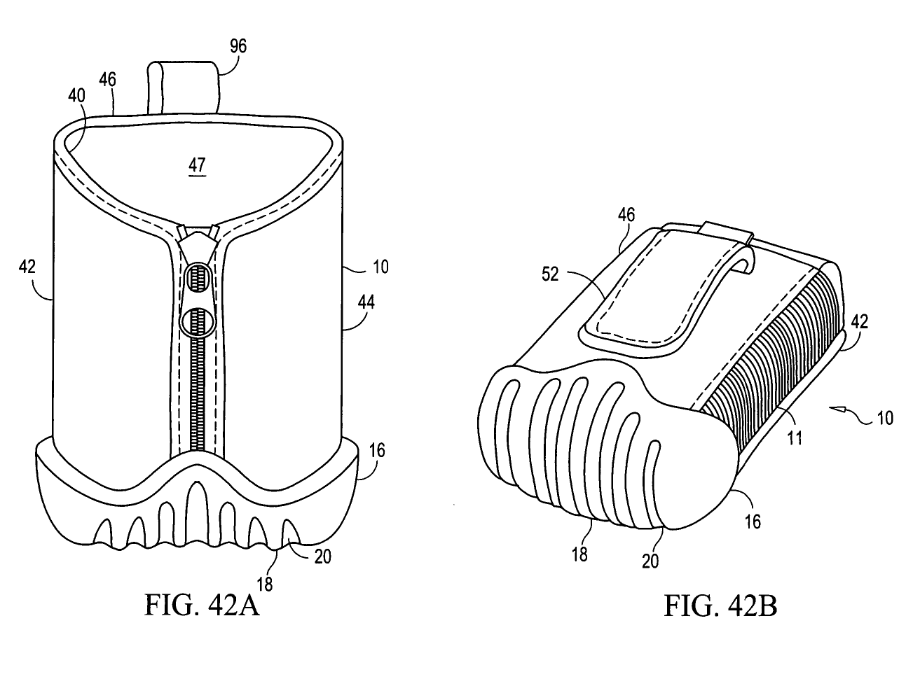

FIG. 41 shows a region of cushion material 34 next to edge pad 14. V-shaped cutout 90 is also shown in FIG. 41.

FIG. 42 A shows carrying case 10 with an end cap 16 having ridges 18 and valleys 20. Rear wall 46 includes a tether loop 96. Loop 96 can be used with a tether loop that spans about the neck of the user or over the shoulder of the user.

FIG. 42B shows carrying case 10 with elastic panel 11 on side 42. The right side also includes an elastic panel. The rear wall 46 includes clip attachment 52.

FIG. 43A shows that end cap 16 only partially laterally spans region 98 of bottom end 110 of case 10. Further, the end cap longitudinally extends a sizable distance 112 above the bottom of the carrying case 10. Laces 82 are mounted with a tether strap 114 and tether strap 114 can be looped around the neck or the shoulder of the user. The lacing fastener system can permit adjustment of the interior space between walls 40, 42, 44 and the rear wall (not shown) such that case 10 can carry phones or devices of different sizes.

FIG. 43B is a different view of carrying case 10 shown in FIG. 43A.

The claims appended hereto are meant to cover modifications and changes within the scope and spirit of the present invention.

What is claim is:

1. A carrying case for a cell phone, a personal data assistant, a digital camera, a digital memory store music player, portable game player or other personal electronic device, said cell phone or personal electronic device having a bottom end, said carrying case comprising:
a front, a rear and two opposing sides adapted to encase said cell phone or personal electronic device; and
a resilient plastic bottom end cap attached to said front, rear and two opposing sides, said end cap forming a protective shield for the bottom end of said cell phone or personal electronic device.

2. A carrying case as claimed in claim 1 wherein said end cap is made of compressible plastic.

3. A carrying case as claimed in claim 1 wherein said end cap includes either recessed grooves or raised lands.

4. A carrying case as claimed in claim 1 wherein said end cap includes tactile response structures in the form of either recessed grooves or raised lands.

5. A carrying case as claimed in claim 1 wherein said end cap includes a front side wall element and opposing side wall elements.

6. A carrying case as claimed in claim 5 wherein said front side wall element and opposing side wall elements include either recessed grooves or raised lands.

7. A carrying case as claimed in claim 5 wherein said front side wall element and opposing side wall elements include tactile response structures in the form of either recessed grooves or raised lands.

8. A carrying case as claimed in claim 3 wherein said recessed grooves or raised lands establish a shock absorbent structure on said end cap.

9. A carrying case as claimed in claim 6 wherein said front side wall element and opposing side wall elements establish shock absorbent structures on said end cap.

10. A carrying case as claimed in claim 1 wherein front and rear sides of said carrying case have a lateral span and said resilient plastic bottom end cap partially covers said lateral span of said front and rear sides of said carrying case.

11. A carrying case as claimed in claim 1 wherein said end cap includes a partial front wall element and one side wall element.

12. A carrying case as claimed in claim 1 wherein said front, rear and two opposing sides define an open top and a mouth adapted to receive said cell phone or personal electronic device; and
a soft cushion edge pad along said front side at said open top and mouth adapted to facilitate insertion and removal of said cell phone or personal electronic device.

13. A carrying case as claimed in claim 12 wherein said edge pad includes a V-shaped cut-out to facilitate insertion and removal of said cell phone or personal electronic device.

14. A carrying case as claimed in claim 1 wherein said front side includes bands of cushioning material and defining shock resilient elements to protect said cell phone or personal electronic device.

15. A carrying case as claimed in claim 14 wherein said bands of cushioning material include raised lands of resilient plastic.

16. A carrying case as claimed in claim 14 wherein said opposing sides include side bands of cushioning material.

17. A carrying case as claimed in claim 16 wherein said side bands include raised lands of resilient plastic.

18. A carrying case as claimed in claim 17 wherein said raised lands on said side bands establish tactile grip regions about said carrying case.

19. A carrying case as claimed in claim 1 wherein said opposing sides include a first opposing side and a second opposing side, one of said front side or said first or second sides including a swath of elastic adapted to laterally compress said cell phone or personal electronic device disposed in said carrying case.

20. A carrying case as claimed in claim 19 including a releasable fastener extending over said swath of elastic.

21. A carrying case as claimed in claim 20 wherein said releasable fastener includes a fastener from the group comprising a hook and loop cloth fastening system, a button, belted clasp, a snap, a clasp, and a lacing system with laces.

22. A carrying case as claimed in claim 21 wherein said releasable fastener includes a lacing system with laces and said carrying case includes a tether loop mounted to said lacing system.

23. A carrying case for a cell phone, personal data assistant, a digital camera, a digital memory store music player, portable game player or other personal electronic device comprising:
a front, a rear, two opposing sides and a bottom cap adapted to encase said cell phone or personal electronic device, said front, rear and two opposing sides defining an open top and a mouth adapted to receive said cell phone or personal electronic device; and
a soft cushion edge pad along said front side at said open top and mouth adapted to facilitate insertion and removal of said cell phone or personal electronic device.

24. A carrying case as claimed in claim 23 wherein said edge pad includes a V-shaped cut-out to facilitate insertion and removal of said cell phone or personal electronic device.

25. A carrying case for a cell phone, a personal data assistant, a digital camera, a digital memory store music player, portable game player or other personal electronic device comprising:
a front, a rear, two opposing sides and a bottom cap adapted to encase said cell phone or personal electronic device; and
said front side including bands of cushioning material and defining shock resilient elements to protect said cell phone or personal electronic device.

26. A carrying case as claimed in claim 25 wherein said bands of cushioning material include raised lands of resilient plastic.

27. A carrying case as claimed in claim 26 wherein said opposing sides include side bands of cushioning material.

28. A carrying case as claimed in claim 27 wherein said side bands include raised lands of resilient plastic.

29. A carrying case as claimed in claim 25 wherein said cell phone or other personal electronic device includes an audio announcer and said bands of cushioning material are spaced laterally away from said audio announcer.

30. A carrying case as claimed in claim 28 wherein said raised lands on said side bands establish tactile grip regions about said carrying case.

31. A carrying case for a cell phone, a personal data assistant, a digital camera, a digital memory store music player, portable game player or other personal electronic device comprising:
a front side, a rear side, a first opposing side and a second opposing side and a bottom cap adapted to encase said cell phone or personal electronic device, one of said front side or said first or second sides including a swath of elastic adapted to laterally compress said cell phone or personal electronic device disposed in said carrying case.

32. A carrying case as claimed in claim 31 including a releasable fastener extending over said swath of elastic.

33. A carrying case as claimed in claim 32 wherein said releasable fastener includes a fastener from the group comprising a hook and loop cloth fastening system, a button, a snap, a belted clasp, a clasp, and a lacing system with laces.

34. A carrying case as claimed in claim 32 wherein said releasable fastener includes a lacing system with laces and said carrying case includes a tether loop mounted to said lacing system.
